(19) United States
(12) Patent Application Publication
(10) Pub. No.: US 2012/0240332 A1
(43) Pub. Date: Sep. 27, 2012

(54) Patient Support for Handling and Transfers

(75) Inventors: Frederic Palay, Sugarloaf Key, FL (US); William E. Burak, JR., San Antonio, TX (US)

(73) Assignee: KCI LICENSING, INC., San Antonio, TX (US)

(21) Appl. No.: 13/396,888

(22) Filed: Feb. 15, 2012

Related U.S. Application Data
(60) Provisional application No. 61/466,589, filed on Mar. 23, 2011.

(51) Int. Cl. A61G 7/10; A47C 20/02

(52) U.S. Cl. 5/83.1; 5/652

(57) ABSTRACT

In accordance with one embodiment of the present invention, a patient support may generally consist of a single L-shaped piece of material with one portion of the patient support comprising a back support and one portion of the patient support comprising a leg support. The patient support may be folded into the general shape of a seat and the distal end of the leg support may attach to the distal end of the back support. The point of attachment of the leg support to the back support may be adjusted to increase or decrease the size of the patient support and to change the angular position of a patient in the patient support. The patient support may also include an upper back support and a head support. In one embodiment, the patient support may include a hand hold.

### CROSS REFERENCE TO RELATED APPLICATIONS

This non-provisional application claims priority based upon prior U.S. Provisional Patent Application Ser. No. 61/466,589 filed Mar. 23, 2011 in the name of Frederic Palay and William E. Burak, Jr. M.D., entitled “Patient Support for Handling and Transfers,” the disclosure of which is incorporated herein by reference.

### BACKGROUND OF THE INVENTION

The present invention relates generally to patient handling systems and, more particularly, to patient supports that may be used with patient handling systems.

Many patient handling systems, such as floor-based hoists, ceiling lifts, and lateral transfer systems, employ patient supports to hold a suspended patient during transfer. Existing patient supports have many limitations. For example, existing patient supports are often comprised of one or more slings that must be properly sized to and positioned on a patient's torso. Proper sizing and positioning can be difficult, however, because of the differences in shapes and sizes of patients' torsos. Improper sizing and positioning of slings on the patient's torso can lead to patient discomfort or injury. Placement of a sling too close to a patient's knees or too high on a patient's back, for example, could force the patient into an extreme fetal position or unintentionally place the patient in an undesired forward-titled or back-tilted position. Lifting a patient in a sling that is improperly sized or positioned can also cause unwanted and dangerous swinging, swiveling or bending of the suspended patient. Also, if separately-sized slings are used together to support, for example, a patient's legs and a patient's back, then a caregiver must be careful to avoid inadvertently switching the separately-sized slings. In addition, slings are often improperly positioned because of difficulty in placing the slings underneath a patient while the patient is lying in bed or sitting in a chair.

### SUMMARY OF THE INVENTION

In accordance with one embodiment of the present invention, a patient support may generally consist of a single L-shaped piece of material with one portion of the patient support comprising a back support and one portion of the patient support comprising a leg support. The patient support may be folded into the general shape of a seat and the distal end of the leg support may attach to the distal end of the back support. The point of attachment of the leg support to the back support may be adjusted to increase or decrease the size of the patient support and to change the angular position of a patient in the patient support. The patient support may also include a strap that attaches to the leg support and may be used to attach the patient support to a patient handling device. The patient support may also include a positioning belt for adjusting the angular position of a patient. The patient support may also include an upper back support and a head support. In one embodiment, the patient support may include hand mittens. The hand mittens may be used by a caregiver to position the leg support under a patient's legs and to position the back support behind a patient's back.

It can be appreciated that there is a significant need for a patient support that generally may be comprised of a single piece of material. It can further be appreciated that there is a significant need for a patient support that can fit multiple shapes and sizes of patient's torsos. It can further be appreciated that there is a significant need for a patient support that can be easily positioned on a patient's torso. It can further be appreciated that there is a significant need for a patient support that will position a supported patient in an upright position without unwanted and dangerous swinging, swiveling or bending of the suspended patient. It can further be appreciated that there is a significant need for a patient support that can be easily placed underneath a patient while the patient is lying in bed or sitting in a chair. Embodiments of the present invention can provide these and other advantages, as will be apparent from the following detailed description and accompanying figures.

### DESCRIPTION OF THE DRAWINGS

FIG. 1 shows a top view of the outer surface of one embodiment of the patient support of the present invention.

FIG. 2a shows a perspective view of one embodiment of the patient support of the present invention with the patient support sized large.

FIG. 2b shows a perspective view of one embodiment of the patient support of the present invention with the patient support sized medium.

FIG. 2c shows a perspective view of one embodiment of the patient support of the present invention with the patient support sized small.

FIGS. 3a-c show examples of embodiments of the patient support of the present invention in use with various patient handling systems.

FIG. 4a shows a perspective view of the inner surface of one embodiment of the patient support of the present invention with an upper back support and a head support.

FIG. 4b shows a perspective view of one embodiment of the patient support of the present invention with an upper back support and a head support.

FIGS. 5a-b show examples of embodiments of the patient support of the present invention with looped straps.

FIG. 6 shows one embodiment of the patient support of the present invention with a positioning belt and handles.

FIG. 7 shows one embodiment of the patient support of the present invention with handles.

FIG. 8 shows one embodiment of the patient support of the present invention with a hand mitten.

FIGS. 9a-c show examples of positioning one embodiment of the patient support of the present invention under the legs of a patient and with a hand mitten.

FIGS. 10a-c show examples of positioning one embodiment of the patient support of the present invention behind the back of a patient and with a hand mitten.

### DESCRIPTION OF THE PREFERRED EMBODIMENTS

In one embodiment, the present invention comprises a patient support that may generally consist of a single L-shaped piece of material with a first elongate member comprising a back support and a second elongate member comprising a leg support. The patient support may be folded into the general shape of a seat and the distal end of the leg support may attach to the distal end of the back support. The point of attachment of the leg support to the back support may be adjusted to increase or decrease the size of the patient support and to change the angular position of a patient in the patient support. The patient support may also include a strap that attaches to the leg support and may be used to attach the patient support to a patient handling device. The patient support may also include a positioning belt for adjusting the angular position of a patient. The patient support may also include an upper back support and a head support. In one embodiment, the patient support may include hand mittens. The hand mittens may be used by a caregiver to position the leg support under a patient's legs and to position the back support behind a patient's back.

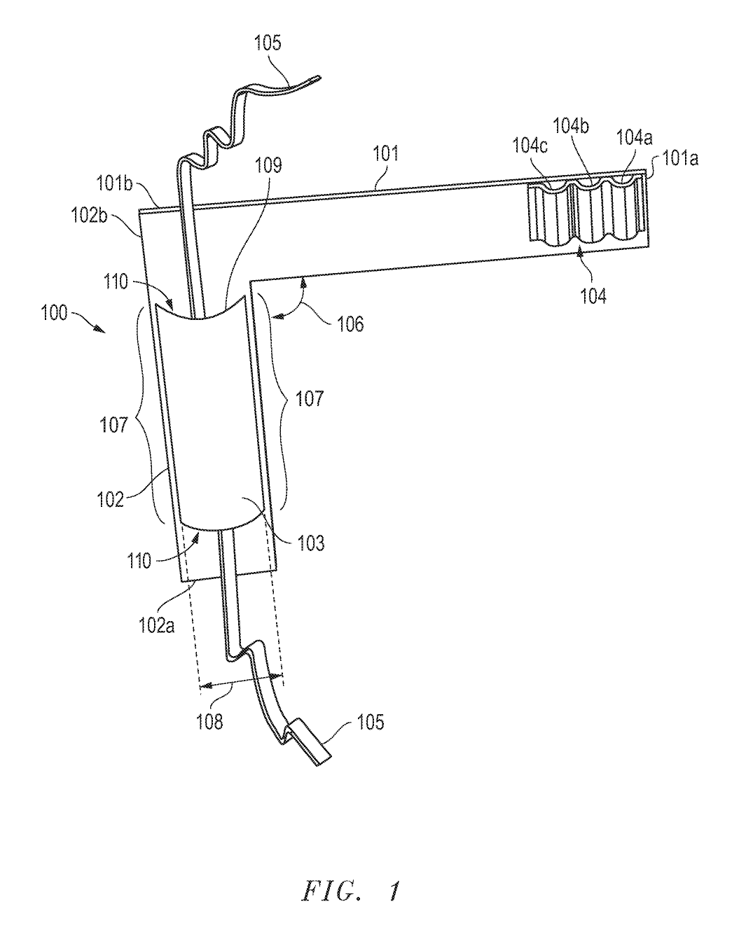

Reference is now made to FIG. 1 which shows a top view of the outer surface of one embodiment of the patient support 100 of the present invention. In this embodiment, the patient support 100 is generally L-shaped with one portion of the patient support 100 comprising a back support 101 and one portion of the patient support 100 comprising a leg support 102. The intersection of the back support 101 and the leg support 102 may form an angle of approximately ninety degrees 106. In one embodiment, the back support 101 and the leg support 102 may generally consist of a single piece of material. The material may consist of a fabric and may include fabrics with low coefficients of friction for human skin. In other embodiments, the back support 101 and the leg support 102 may consist of separate pieces of material with the proximal end 101b of the back support 101 joined to the proximal end 102b of the leg support 102. In this embodiment, the length of the back support 101 is approximately the same as the length of the leg support 102. In other embodiments, the relative length of the back support 101 compared to the leg support 102 may be shorter or longer. The back support 101 and the leg support 102 are each shown to be generally rectangular in shape in this embodiment.

The patient support 100 may also include a lower strap 105 or other fastening means. The lower strap 105 may consist of adjustable length webbing that may be used to attach the patient support 100 to a patient lifting device and to support the weight of a patient. In this embodiment, the lower strap 105 is shown passing along the outer surface of the leg support 102. In other embodiments, the patient support 100 may include a first lower strap 105 that attaches to the proximal end 101b of the back support 101 (or the proximal end 102b of the leg support 102) and a second lower strap 105 that attaches to the distal end 102a of the leg support 102 (or the distal end 101a of the back support 101). The lower strap 105 and/or the patient support 100 may also include fasteners to attach, for example, the lower strap 105 to the patient support 100.

In one embodiment, the patient support 100 may include a hand hold which may allow a user to position the patient support 100 underneath a patient. In FIG. 1, for example, a hand hold is shown as a hand mitten 103 that is generally centered on the outer surface of the leg support 102 between the proximal end 102b and the distal end 102a of the leg support 102. In this embodiment, the hand mitten 103 does not extend to the proximal end 102b or the distal end 102a of the leg support 102. The hand mitten 103 may consist of a generally rectangular piece of fabric that is connected to the leg support 102 by sewing, or otherwise attaching, the lengths 107 of the generally rectangular piece of fabric to the leg support 102. The distance 108 between the lengths 107 of the generally rectangular piece of fabric may be less than the width 109 of the generally rectangular piece of fabric but great enough that a caregiver's hand may fit into the pockets 110 formed by the generally rectangular piece of fabric's attachment to the leg support 102. The hand mitten 103, or at least its outer surface, may also include a material with a low coefficient of friction on sheets. It can be appreciated that other embodiments of the hand mitten 103 may include other shapes, sizes, and configurations, such as a pocket, strap, band, belt, strip, tie, fastener, recess, indentation, and/or ridge, for example, without departing from the spirit and scope of the invention. In other embodiments, the back support 101 may also include a hand mitten 103.

In this embodiment, the patient support also includes a closing system 104 on the outer surface of, and at the distal end 101a of, the back support 101. The closing system 104 may include a means for sizing the patient support with, for example, attachment loops 104a-c placed at different positions along the distal end 101a of the back support 101. It can be appreciated that other embodiments may include other closing mechanisms, such as fasteners, for example, without departing from the spirit and scope of the invention.

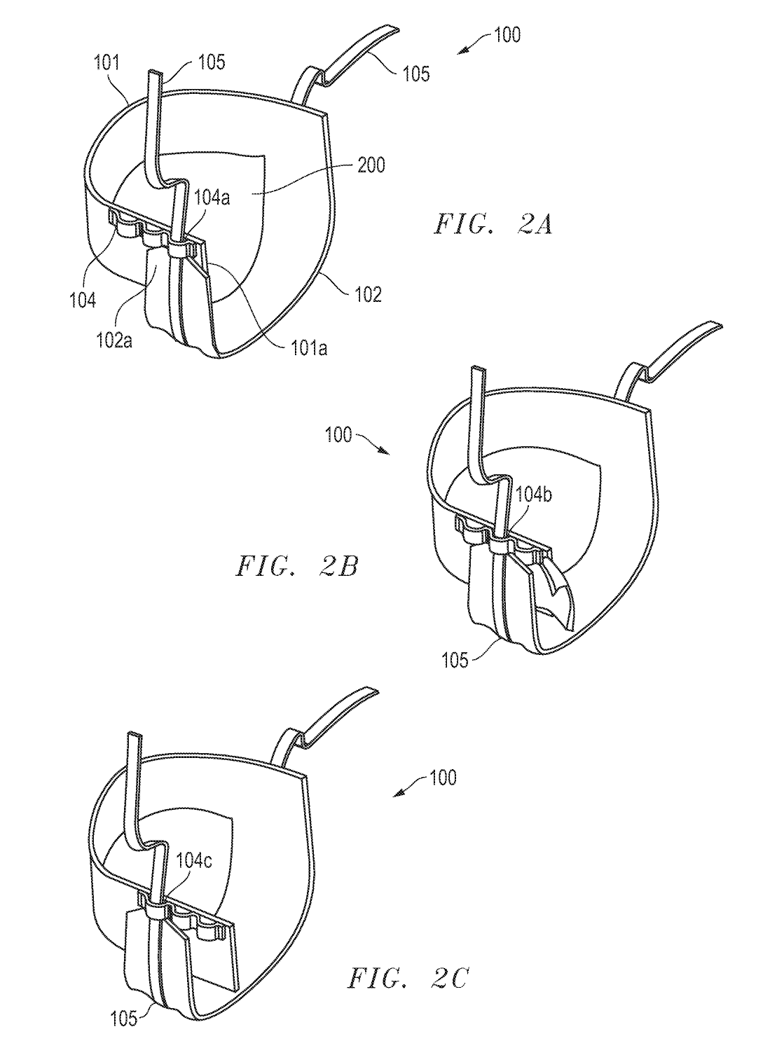

Reference is now made to FIG. 2a which shows a perspective view of one embodiment of the patient support 100 of the present invention with the patient support 100 sized large. In this embodiment, the patient support 100 has been folded such that the back support 101 is generally u-shaped with the inner surface of the back support 101 being concave, the leg support 102 is generally u-shaped with the inner surface of the leg support 102 being concave, and, the inner surface of the distal end 102a of the leg support 102 is attached to the outer surface of the distal end 101a of the back support 101. The back support 101 and the leg support 102 are also arranged in a generally perpendicular configuration. As a result, the patient support 100 has been folded to effectively form the shape of a seat with an open region 200. In other embodiments, the outer surface of the distal end 102a of the leg support 102 may attach to the inner surface of the distal end 101a of the back support 101.

In this embodiment, the lower strap 105 has been threaded through a first attachment loop 104a of the closing system 104 so that the patient support 100 is sized large. By sizing the patient support 100 large, the effective length of the back support 101 is increased and may better fit a larger patient. In addition, the juncture at which the lower strap 105 connects to the back support 101 may form a pivot point when the patient support 100 is suspended by the lower strap 105. Placement of the lower strap 105 at different points along the back support 101 can be used to change the position of the pivot point and the relative distance between the pivot point and the center of gravity of a patient supported by the patient support 100. As a result, placement of the lower strap 100 at different points along the back support 101 can be used to adjust the angular position of a seated patient from, for example, generally upright to slightly reclined.

Reference is now made to FIG. 2b which shows a perspective view of one embodiment of the patient support 100 of the present invention with the patient support 100 sized medium. In this embodiment, the lower strap 105 has been threaded through a second attachment loop 104b of the closing system 104 so that the patient support 100 is sized medium.

Reference is now made to FIG. 2c which shows a perspective view of one embodiment of the patient support 100 of the present invention with the patient support 100 sized small. In this embodiment, the lower strap 105 has been threaded through a third attachment loop 104c of the closing system 104 so that the patient support 100 is sized small.

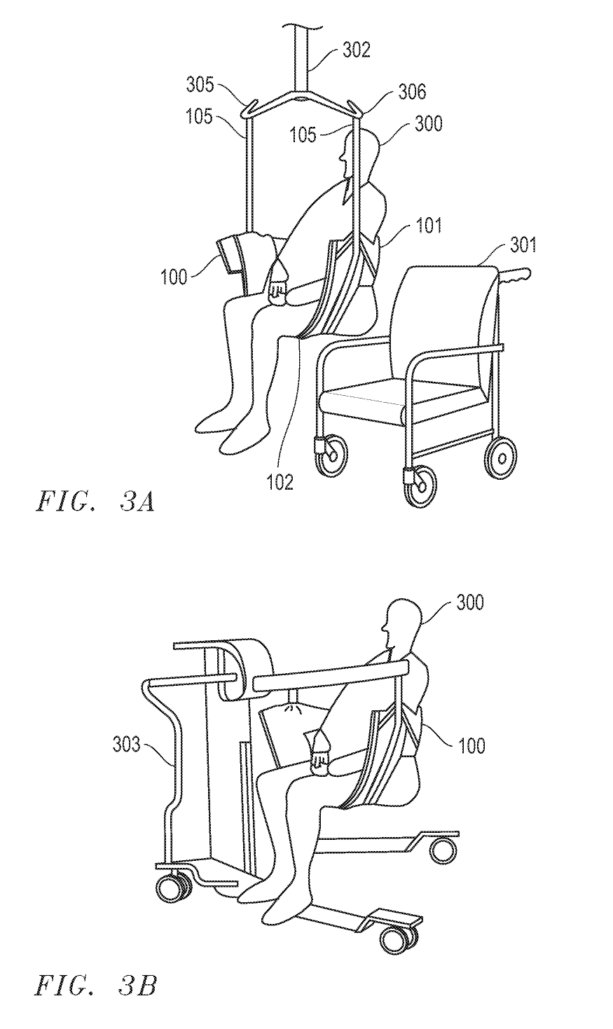

Reference is now made to FIGS. 3a-c which show examples of embodiments of the patient support 100 of the present invention in use with various patient handling systems. In FIG. 3a, a patient 300 has been lifted out of a chair 301 with a lifting device 302 from the front side of the chair 301. One embodiment of the patient support 100 is shown supporting the weight of the patient 300. The leg support 102 is shown positioned under the thighs of the patient 300. The back support 101 is shown positioned around the middle of the back of the patient 300. The lower strap 105 is shown passing along the outside surface of the leg support 102 and connecting to the patient lifting device 302 with only two points of attachment 305 and 306. The patient 300 is shown to be positioned in a generally upright seated position after a frontal transfer from the chair. In FIG. 3b, a different style of patient lifting device 303 is shown to have lifted a patient 300 that is supported by one embodiment of the patient support 100. In FIG. 3c, a patient lifting device 303 is shown to have lifted a patient 300 that is supported by one embodiment of the patient support 100. The patient 300 is in the process of being laterally transferred into or out of the seat of a car 304. In this embodiment, the upright position of the patient 300 in the patient support 100 allows for an easy lateral transfer to or from the seat of the car 400 without unwanted swiveling, swinging or bending of the patient 300.

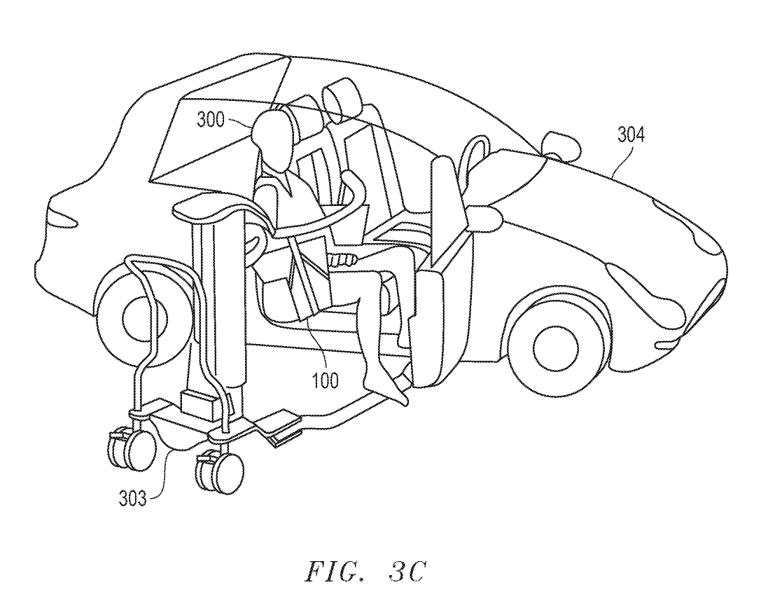

Reference is now made to FIG. 4a which shows a perspective view of the inner surface of one embodiment of the patient support 400 of the present invention with an upper back support 401 and a head support 402. In this embodiment, the upper back support 401 extends from the upper portion 403 of the back support 101, approximately centered between the distal end 101a and the proximal end 101b of the back support 101. In this embodiment, the width 404 of the upper back support 401 is approximately half the length 405 of the back support 101. In this embodiment, a head support 402 extends from the upper portion of the upper back support 401. The head support 402 is approximately centered between the patient-left side 407 and patient-right side 408 of the upper back support 401. The patient support 400 may also include an upper strap 406 that may connect to the patient support 400 at or near the intersection 409 of the head support 402 and the upper back support 401. The upper strap 406 may extend from the patient-right and patient-left sides of the head support 402 or the upper back support 401. In one embodiment, the upper strap 406 may be pulled taut in order to hold the head support 402 against a patient's head and to provide support to the patient's head and neck. For example, the upper strap 406 may be pulled taut and attached to a lifting device, the patient support 400 or the lower strap 105.

FIG. 4b shows a perspective view of one embodiment of the patient support 400 of the present invention with an upper back support 401 and head support 402. In this embodiment, the leg support 102 and the back support 101 of the patient support 400 have been folded and connected at their distal ends to form the patient support 400 into the shape of a seat. In one embodiment, the outer surface of the upper back support 401 may include one or more hand mittens (not shown).

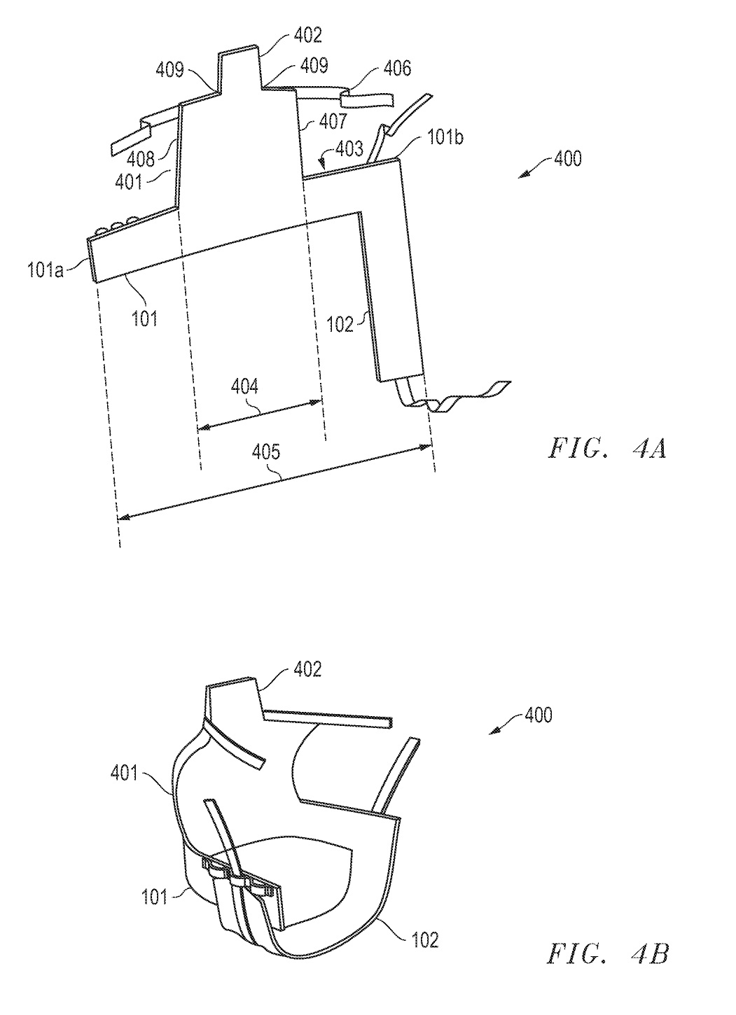

Reference is now made to FIGS. 5a-b which show examples of embodiments of the patient support of the present invention with looped straps. In FIG. 5a, the lower strap 500 is shown to consist of two straps 501 and 502 that have a loop at the patient-left end 503a and a loop at the patient-right end 504a of the lower strap 500. The two strips 501 and 502 may consist of a single piece of webbing, for example, to form the loops 503a and 504a or may be separate pieces that are joined to together to form the loops 503a and 504a. In this embodiment, the lower strap 500 contains multiple loops 503a-d and 504a-d. One or more of the multiple loops 503a-d and 540a-d may be used to connect the patient support 100 to a patient lifting device. If the loops 503a and 504a are used to connect the patient support 100 to a patient lifting device, then the distance between the patient support 100 and the portion of the lifting device that connects to the patient support 100 will be less than if the loops 503d and 504d are used to connect the patient support 100 to a patient lifting device. As a result, the height of a supported patient relative to a lifting device may be increased or decreased based on the choice of loops 503a-d and 504a-d that are used to connect the patient support 100 to a patient lifting device. In FIG. 5b, upper straps 505 of one embodiment of the patient support 400 are shown to include multiple loops 506 and 507. In one embodiment, the multiple loops 503a-d, 504a-d, 506, and 507 may be color coded.

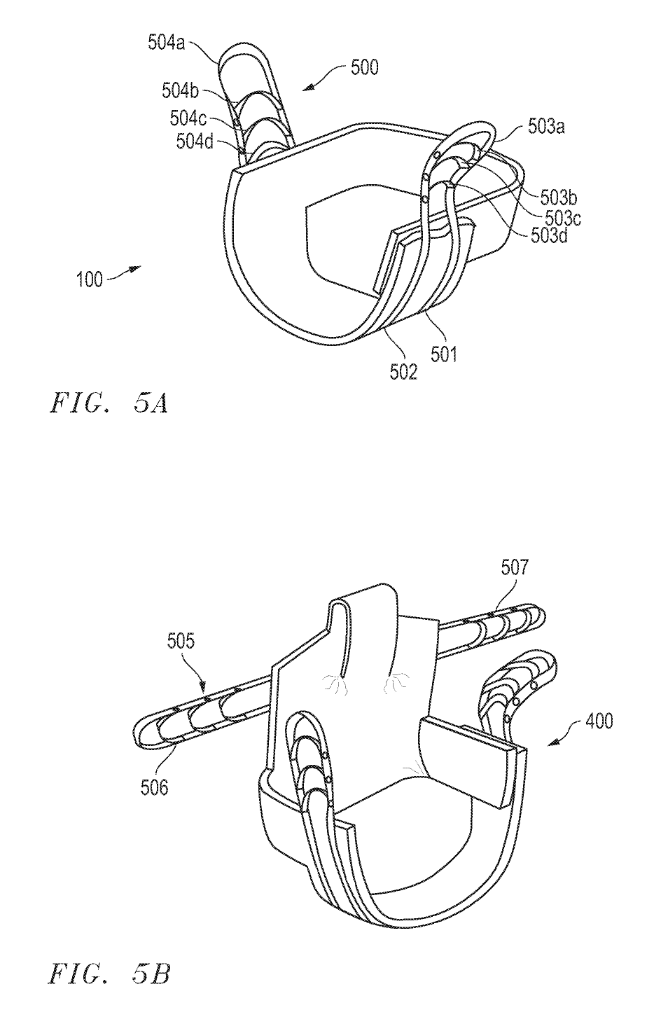

Reference is now made to FIG. 6 which shows one embodiment of the patient support 600 of the present invention with a positioning belt 601 and handles 602 and 603. In this embodiment, the patient support 600 includes a positioning belt 601 that may attach to the lower strap 105 and the back support 101. While FIG. 6 only shows a positioning belt 601 on the left side of the patient 300, the patient support 600 may include another positioning belt 601 on the right side of the patient 300. In this embodiment, the positioning belt 601 attaches to the lower strap 105 at a portion of the lower strap 105 that extends above the patient support 600. In one embodiment, the positioning belt 601 attaches to the lower strap 105 at a height at or around the height of the chest of the patient 300 and attaches to the back sling 101 at or around a portion of the back sling 101 that is generally below the shoulder of the patient 300. In this embodiment, tightening (or shortening) the positioning belt 601 will cause the patient 300 to be positioned more upright and loosening (or lengthening) the positioning belt 601 will cause the patient 300 to be positioned with a greater recline.

The patient support 600 may also include handles 602 and 603 attached to the back support 101. In this embodiment, two handles 602 and 603 are shown attached on the outer surface of the back sling. One handle 602 is generally near the proximal end 101b of the back support 101 and one handle 603 is generally centered between the proximal end 101b and the distal end 101a of the back support 101.

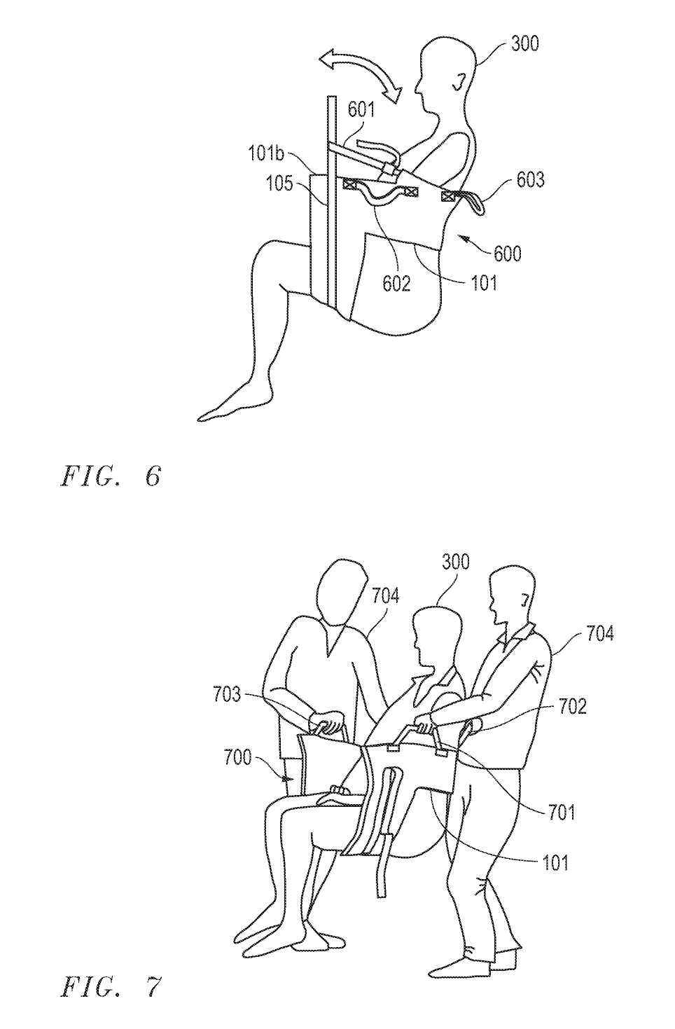

Reference is now made to FIG. 7 which shows one embodiment of the patient support 700 of the present invention with handles 701-703. In this embodiment, three handles 701-703 are shown attached on the outer surface of the back sling: one handle 701 is generally near the proximal end 101b of the back support 101, one handle 702 is generally centered between the proximal end 101b and the distal end 101a of the back support 101, and one handle 703 is generally near the distal end 101a of the back support 101. Caregivers 704 are shown manually transferring a patient 300 in the patient support 700 by grasping the handles 701-703.

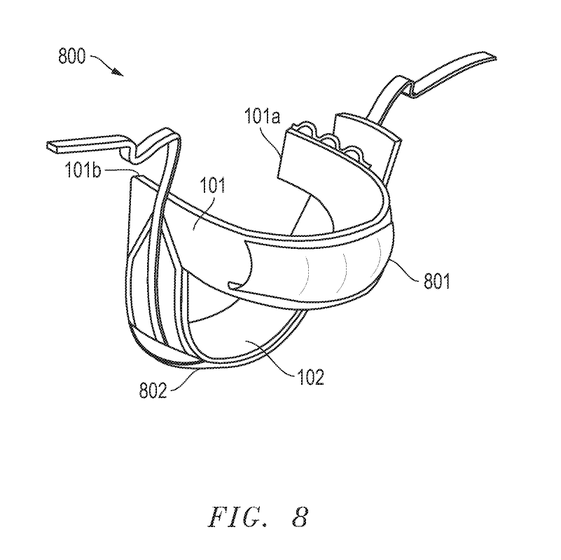

Reference is now made to FIG. 8 which shows one embodiment of the patient support 800 of the present invention with hand mittens 801 and 802. In this embodiment, a first hand mitten 801 is shown attached to the outer surface of a portion of the back support 101. In this embodiment, the first hand mitten 801 is generally centered between the proximal end 101b and the distal end 101a of the back support 101. In this embodiment, however, the first hand mitten 801 does not extend to the proximal end 101b or the distal end 101a of the back support 101. The leg support 102 is shown to include a second hand mitten 802.

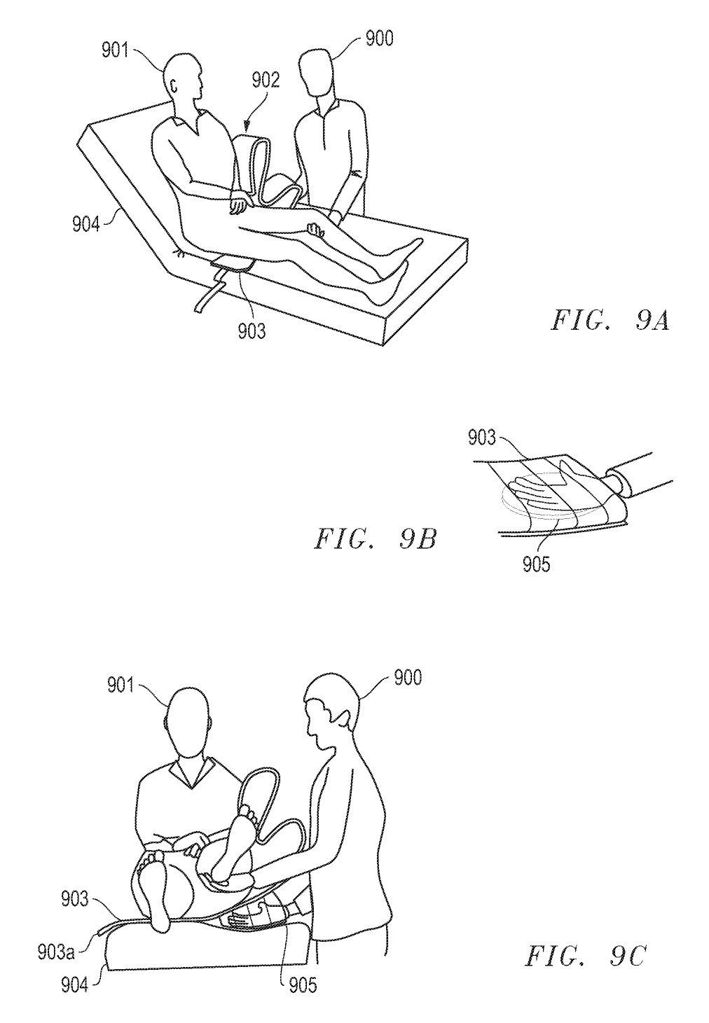

Reference is now made to FIGS. 9a-c which show examples of positioning one embodiment of the patient support of the present invention under the legs of a patient 901 and with a hand mitten 905. FIG. 9a shows a perspective view of a patient 901 sitting on a bed 904. A caregiver 900 is standing to the side of the bed 904 and is positioning the leg support 903 of the patient support 902 underneath the thighs of the patient 901. The left hand of the caregiver 900 is shown holding the left leg of the patient 901 slightly above the surface of the bed 904. In FIG. 9b, the right hand of the caregiver 900 is shown inside the hand mitten 905 of the leg support 903. FIG. 9c shows a front view of the patient 901 on the bed 904. The caregiver 900 is shown to side of the patient 901. The left hand of the caregiver 900 is shown holding the left leg of the patient 901 slightly above the surface of the bed 904. The right hand of the caregiver 900 is shown to be inside the hand mitten 905 of the leg support 903 and is being used to position the leg support 903 underneath the leg of the patient 901. By placing her hand in the hand mitten 905, the caregiver 900 can push and slide the leg support 903 under the legs of the patient 901 without touching the skin of the patient 901. While not shown, in one embodiment, the caregiver 900 may also stand to the other side of the patient 901 and insert her hand into a hand mitten from the distal end 903a of the leg support 903 in order to position the leg support 903 under one or both of the legs of the patient 901.

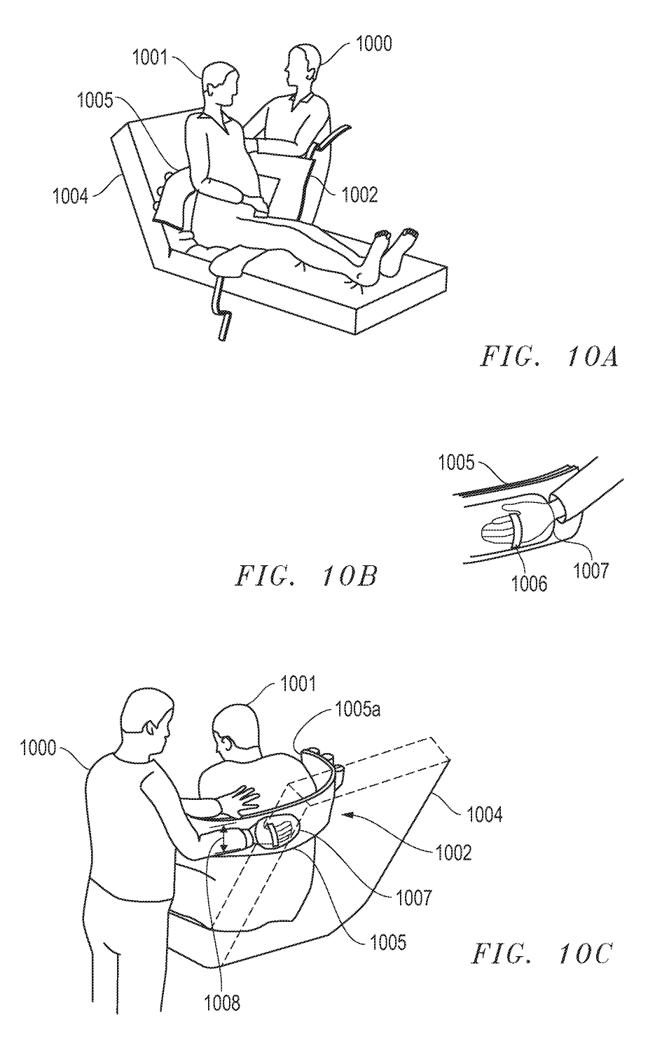

Reference is now made to FIGS. 10a-c which show examples of positioning one embodiment of the patient support 1002 of the present invention behind the back of a patient and with a hand mitten 1007. FIG. 10a shows a perspective view of a patient 1001 sitting on a reclining adjustable bed 1004. A caregiver 1000 is standing to the side of the bed 1004 and is positioning the back support 1005 of the patient support 1002 behind the back of the patient 1001. In FIG. 10b, the left hand of the caregiver 1000 is shown inside the hand mitten 1007 of the back support 1005. In this embodiment, a strap 1006 is also shown attached to the leg support 1005 underneath the hand mitten 1007. The strap 1006 may allow the caregiver 1000 to grasp the back support 1005 more firmly from within the hand mitten 1007. Other embodiments may include the hand mitten 1007 without the strap 1006, the strap 1006 without the hand mitten 1007, and/or other shapes, sizes, and configurations of hand holds that would allow a user to grasp the patient support 1002. For example, other embodiments may include various configurations of a pocket, strap, band, belt, strip, tie, fastener, recess, indentation, and/or ridge to aid a user in positioning the patient support 1002 or a portion thereof.

FIG. 10c shows a back view of the patient 1001 on the bed 1004. The caregiver 1000 is shown to side of the patient 1001. The left hand of the caregiver 1000 is shown to be placed against the back of the left shoulder of the patient 1001, holding the upper back of the patient 1001 slightly above the surface of the bed 1004. The right hand of the caregiver 1000 is shown to be inside the hand mitten 1007 of the back support 1005 and is being used to position the back support 1005 underneath the back of the patient 1001. The width 1008 of the hand mitten 1007 is generally parallel to the length of the torso of the patient 1001 wearing said patient support 1002 and perpendicular to the length of the back support 1005. The length of the hand-strap 1006 is also generally parallel to the length of the torso of the patient 1001 wearing said patient support 1002 and generally perpendicular to the length of the back support 1005. While not shown, in one embodiment, the caregiver 1000 may also stand to the other side of the patient 1001 and insert her hand into a hand mitten from the distal end 1005a of the back support 1005 in order to position the back support 1005 under the back of the patient 1001.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible devices and methods for patient supports, the detailed embodiments are intended to be illustrative only and should not be taken as limiting the scope of the invention. Rather, what is claimed as the invention is all such modifications as may come within the spirit and scope of the following claims and equivalents thereto.

None of the descriptions in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1-48. (canceled)

49. A patient support comprising:
a first elongate member comprising a back support and extending between a first and second end,
a second elongate member comprising a leg support, said leg support having a first end mated with said first end of said back support and a second end configured to detachably mate with said second end of said back support, said back support and said leg support arranged in a generally perpendicular configuration.

50. (canceled)

51. (canceled)

52. The patient support of claim 49 further comprising a strap that passes along at least a portion of the length of the outer surface of said leg support and extends beyond the length of the outer surface of said leg support on either end of said leg support.

53. (canceled)

54. The patient support of claim 49 wherein said patient support is configured to suspend from a patient lifting device by a first strap attached to said first end of said leg support and by a second strap attached to said second end of said leg support.

55. (canceled)

56. (canceled)

57. The patient support of claim 49 wherein the inner surface of said second end of said leg support is configured to connect to the outer surface of said back support.

58. The patient support of claim 49 wherein either the outer or inner surface of said second end of said leg support includes a closing system.

59. The patient support of claim 49 wherein the outer surface of at least one of said leg support and said back support includes a hand hold.

60. (canceled)

61. The patient support of claim 49 wherein said second end of said leg support is configured to couple to said second end of said back support at different points along said second end of said back support.

62. The patient support of claim 49 wherein at least one of said back support and said leg support is generally rectangular in shape.

63. (canceled)

64. The patient support in claim 49 wherein said leg support and said back support are approximately the same length.

65. The patient support in claim 49 wherein an open area exists between said back support and said seat support when said second end of said leg support is coupled to said second end of said back support.

66. (canceled)

67. (canceled)

68. (canceled)

69. (canceled)

70. The patient support in claim 49 wherein said back support includes at least one of an upper back support, a head support, and a strap configured to attach to said upper back support and/or said head support.

71. The patient support in claim 49 further comprising a positioning belt configured to attach to the top of said back support and to a strap that is coupled to said patient support.

72. (canceled)

73. (canceled)

74. A patient support comprising:
a first elongate portion extending between a first end and a second end, and
a second elongate portion extending from said second end of said first elongate portion in a direction generally perpendicular to said first elongate portion,
said second elongate portion having a distal end configured to detachably connect to said first end of said first elongate portion, wherein the connection of said distal end of said second elongate portion to said first end of said first elongate portion forms a patient support.

75. The patient support of claim 74 further comprising a strap that is coupled to at least a portion of the outer surface of said second elongate portion.

76. (canceled)

77. (canceled)

78. (canceled)

79. The patient support of claim 74 wherein said patient support is configured to suspend from a patient lifting device by a first strap attached to said distal end of said second elongate portion and/or said first end of said first elongate portion and by a second strap attached to a proximal end of said second elongate portion and/or said second end of said first elongate portion.

80. (canceled)

81. (canceled)

82. The patient support of claim 74 wherein the inner surface of said distal end of said second elongate portion is configured to connect to the outer surface of said first end of said first elongate portion.

83. The patient support of claim 74 wherein either the outer or inner surface of said distal end of said second elongate portion includes a closing system.

84. The patient support of claim 74 wherein the outer surface of at least one of said second elongate portion and said first elongate portion includes a hand mitten and/or a hand strap.

85. (canceled)

86. The patient support of claim 74 wherein said distal end of said second elongate portion is configured to couple to said first end of said first elongate portion at different points along said first end of said first elongate portion.

87. The patient support of claim 74 wherein at least one of said first elongate portion and said second elongate portion is generally rectangular in shape.

88. (canceled)

89. The patient support in claim 74 wherein said second elongate portion and said first elongate portion are approximately the same length.

90. The patient support in claim 74 wherein an open area exists between said second elongate portion and said first elongate portion when said distal end of said second elongate portion is coupled to said first end of said first elongate portion.

91. (canceled)

92. (canceled)

93. (canceled)

94. (canceled)

95. The patient support in claim 74 wherein said first elongate portion includes at least one of an upper back support, a head support, and a strap configured to attach to said upper back support and/or said head support.

96. The patient support in claim 74 further comprising a positioning belt configured to attach to said first elongate portion and to a strap that is coupled to said patient support.

97-121. (canceled)

122. A patient support comprising:
a first elongate portion comprising a back support and extending between a first and second end,
a second elongate portion comprising a leg support, said leg support having a first end mated with said first end of said back support and having a second end configured to detachably mate with said second end of said back support,
said back support and said leg support arranged in a generally L-shape with said patient support in an open configuration, and
said back support and said leg support each arranged in a generally u-shape with said patient support in a use configuration.

123. (canceled)

124. (canceled)

125. (canceled)

126. The patient support of claim 122 further comprising a strap that passes along at least a portion of the length of the outer surface of said leg support, extends beyond the length of the outer surface of said leg support on either end of said leg support, and is configured to attach to a patient lifting device.

127. The patient support of claim 122 wherein said patient support is configured to suspend from a patient lifting device by a first strap attached to said first end of said leg support and to said patient lifting device and by a second strap to said second end of said leg support and to said patient lifting device.

128. (canceled)

129. (canceled)

130. The patient support of claim 122 wherein the inner surface of said second end of said leg support is configured to connect to the outer surface of said back support.

131. (canceled)

132. The patient support of claim 122 wherein the outer surface of at least one of said leg support and said back support includes at least one of a hand mitten or a hand strap.

133. (canceled)

134. The patient support of claim 122 wherein said second end of said leg support is configured to couple to said second end of said back support at different points along said second end of said back support.

135. The patient support of claim 122 wherein at least one of said back support and said leg support is generally rectangular in shape.

136. (canceled)

137. The patient support in claim 122 wherein said leg support and said back support are approximately the same length.

138. The patient support in claim 122 wherein said second end of said leg support is configured to couple to said second end of said back support such that an open area is created between said back support and said seat support.

139. (canceled)

140. (canceled)

141. (canceled)

142. (canceled)

143. The patient support in claim 122 wherein said back support includes an upper back support, a head support extending from said upper back support, and a strap configured to attach to said head support.

144. The patient support in claim 122 further comprising a positioning belt configured to attach to the top of said back support and to a strap that is coupled to said patient support.

145. (canceled)

146. The patient support in claim 122 wherein said leg support is configured to be positioned under the thighs of a patient.
